(19) United States
(12) Patent Application Publication
(10) Pub. No.: US 2012/0017172 A1
(43) Pub. Date: Jan. 19, 2012

(54) DISPLAY-AGNOSTIC USER INTERFACE FOR MOBILE DEVICES

(75) Inventors: Sachin Sheth, Bothell, WA (US); Anton Krantz, Redmond, WA (US); Ravi Jaiswal, Hyderabad (IN); Sanjib Biswas, Hyderabad (IN)

(73) Assignee: Microsoft Corporation, Redmond, WA (US)

(21) Appl. No.: 12/836,744

(22) Filed: Jul. 15, 2010

(51) Int. Cl. G06F 3/048

(52) U.S. Cl. 715/800

(57) ABSTRACT

Application user interfaces can be displayed on different sizes and types of displays without having to modify the application for each different display by scaling a layout of the user interface automatically for specific displays, especially smaller size displays such as mobile device displays, reducing a need to create customized versions of the application.

### BACKGROUND

Computer applications interact with human beings through user interfaces. While audio, tactile, and similar forms of user interfaces are available, visual user interfaces through a display device are the most common form of user interface. With the development of faster and smaller electronics for computing devices, smaller size devices such as handheld computers, smart phones, personal digital assistants (PDAs), and comparable devices have become common. Such devices execute a wide variety of applications ranging from communication applications to complicated analysis tools. Many such applications render visual effects through a display and enable users to provide input associated with the applications' operations.

Given the variety of sizes and types of small form computing devices, just as many displays are also used in such devices. A typical user interface for a computer application may include a number of graphical elements, textual components, background images, etc. Thus, the user interface may need to be adjusted in size and layout for different sizes and types of displays. Conventional applications approach this challenge by publishing custom versions of the applications adjusting their user interface for particular classes of displays. Because there is limited standardization in displays, look and feel of user interfaces may be different even for customized applications when executed on computing devices with varying display sizes.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to enabling application user interfaces to be displayed on different sizes and types of displays without having to modify the application for each different display. According to some embodiments, a layout of the user interface for an application may be automatically scaled for specific displays, especially smaller size displays such as mobile device displays, reducing a need to create customized versions of the application.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates how customized versions of an application may be needed for different execution environments with differing display capabilities;

FIG. 2 illustrates how an application user interface may be displayed in various execution environments with differing display capabilities employing a scaling module according to some embodiments;

FIG. 3 illustrates scaling of an application user interface in a system according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of scaling an application user interface according to embodiments.

### DETAILED DESCRIPTION

As briefly described above, application user interfaces can be displayed on different sizes and types of displays without having to modify the application for each different display. A layout of the user interface for an application may be automatically scaled for specific displays. The scaling may include vertical scaling, horizontal scaling, and font scaling. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network.

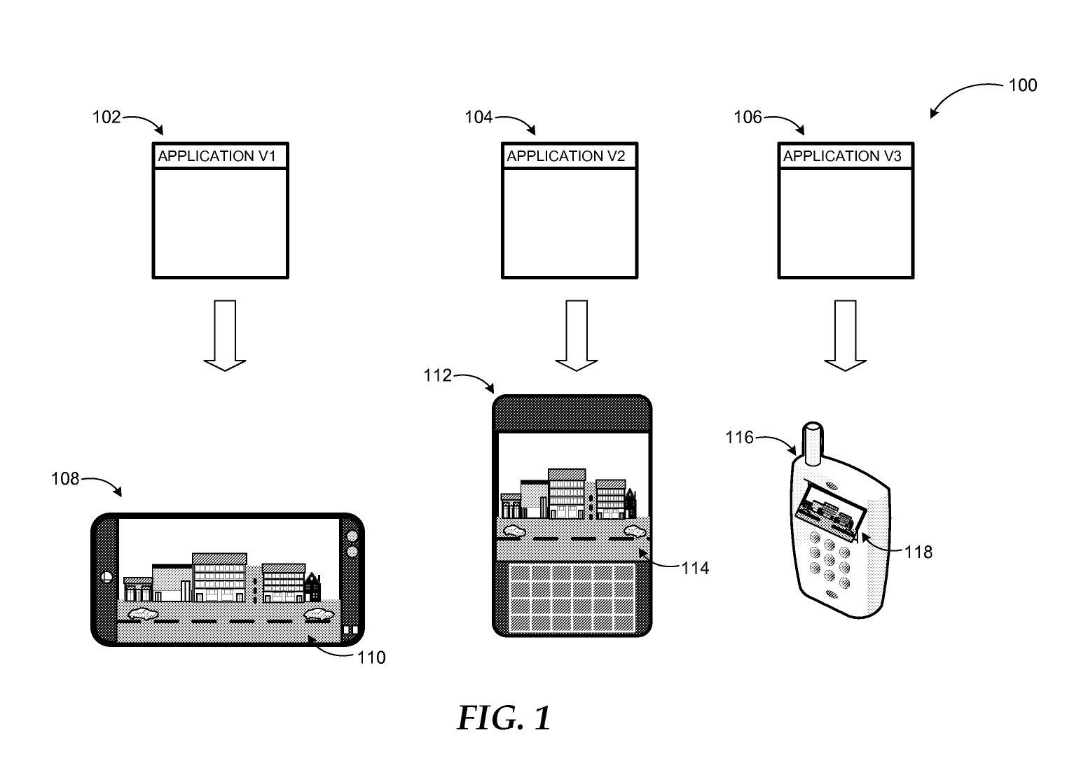

FIG. 1 illustrates how customized versions of an application may be needed for different execution environments with differing display capabilities. As discussed previously, there is limited standardization displays on devices. Typically, the choice of a display for computing devices is dependent on various factors such as cost, desired legibility, device power constraints, and comparable parameters. As a result, there is a limited standardization of displays across devices even running similar applications. If an application has to be executed across multiple devices, the user interface layouts for the application may have to be customized to the specific displays.

Diagram 100 illustrates the rendering of a street view user interface on three example computing devices. A mapping application rendering the street view user interface may have to be customized into three versions 102, 104, and 106, with each custom version being executed on computing devices 108, 112, and 116, respectively. Each computing device may have a different display requiring the customization. The customized versions of the application 102, 104, and 106 may render the custom street view user interfaces 110, 114, and 118 on respective computing devices 108, 112, and 116.

The computing devices may also include handheld computer, a smart phone, a cellular phone, a Voice Over Internet Protocol (VOIP) phone, a set top box, a vehicle mount computer, a tablet computer, a notebook computer, a netbook computer, a wearable computer, and comparable ones.

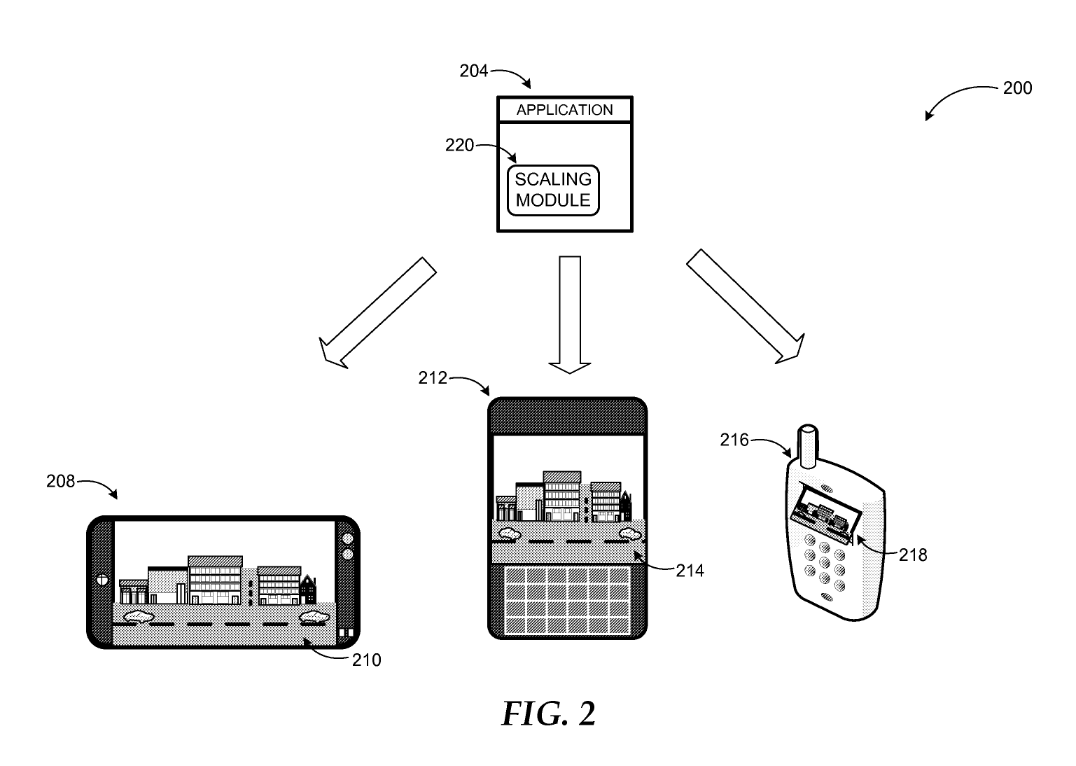

FIG. 2 illustrates how an application user interface may be displayed in various execution environments with differing display capabilities employing a scaling module according to some embodiments.

As shown in diagram 200, an application according to embodiments (e.g. application 204) may include a scaling module 220 for executing an algorithm, which will allow application 204 to be run with different kinds of displays. Through the algorithm, the layout of the application's user interface may be automatically scaled for a specific display such as the displays of computing devices 208, 212, and 216, thereby not requiring customized versions of the application 204.

Scaling module 220 may provide for vertical scaling (i.e. the ability to run from a minimum number of rows to any number of rows) and horizontal scaling (i.e. the ability to run from a predefined display size such as 3.5″ QVGA dimensions to those with smaller dimensions). Scaling module 220 may also provide enable scaling to wider dimensions. In addition to 3.5″ QVGA, other display formats may also be used as default definitions for scaling the user interface to a specific display size. Other display formats may include, but are not limited to, Quarter Video Graphics Array (QVGA), Half VGA (HVGA), Half QVGA (HQVGA), Quarter QVGA (QQVGA), Quarter Extended Graphics Array (QXGA), and Half XGA (HXGA).

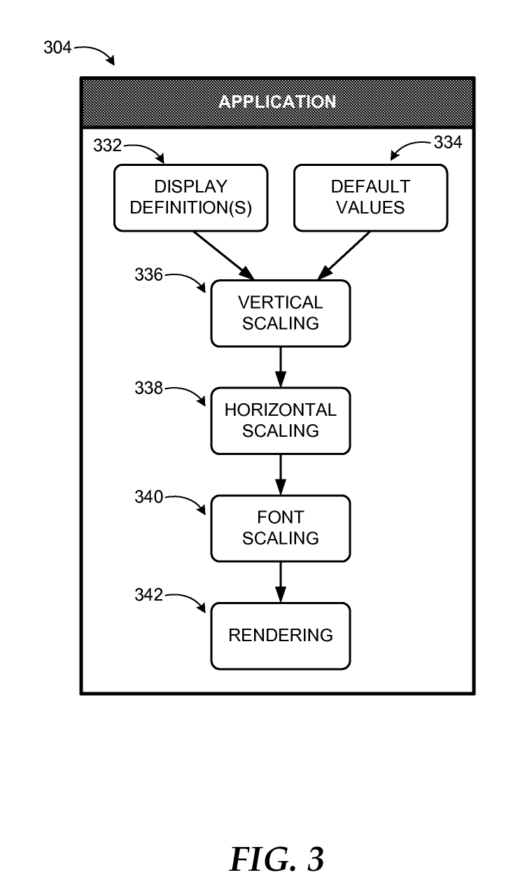

FIG. 3 illustrates scaling of an application user interface in a system according to embodiments. Example application 304 of FIG. 3 may begin a process of adjusting its user interface layout with display definitions 332, where various display parameters are defined for the scaling algorithm to process. Another input for the algorithm may be default values 334 for the display. The process may assume that the pixels of the display are square or rectangular. The fonts on the screen may share an attribute (e.g. bold or regular). The algorithm may work across different languages, but definition values for each language may be different.

The definitions 332 may include parameters such as number of rows and columns, resolution, presence or absence of a top bar, row height, column width, font height, and comparable ones. The example listing below shows a number of definitions that may be used by an algorithm according to embodiments.

NumTotalRows = Total Rows on display
MinTotalRows = Minimum Rows on Screen
MaxTotalRows = Maximum Rows on Screen
DisplayTopBar = Y/N
DisplaySoftKeyBar = Y/N
NumContentRows = Number of rows for displaying content
VRes = Vertical Resolution in pixels for the display
HRes = Horizontal Resolution in pixels for the display
MinRowHt = Minimum Row Height in mm for legibility
RowHt = Row Height in pixels
HoriDPM = Horizontal Dots Per mm for display
VertDPM = Vertical Dots Per mm for display
FontHt = Font Height in pixels
NumTotalColumns = Total Columns in Content Area row
MinColumnWidth = Minimum number of pixels required to display
column for 3.5″ QVGA screen.
If MinColumnWidth=0, the column is not important on constrained
displays.
If display in question is not 3.5″ QVGA, first recalibrate the
value using formula below.
MaxColumnWidth = Maximum number of pixels within which
column can be displayed beyond which become illegible

If display in question is not 3.5″ QVGA, first recalibrate the

value using formula below.
MinContentWidth = Sum of MinColumnWidth for all the columns to be
displayed on the Content area row
MaxContentWidth = Sum of MaxColumnWidth for all the columns to be
displayed on the Content area row
MinTopBarWidth = Sum of MinColumnWidth for all the elements to be
displayed on the Top Bar
MaxTopBarWidth = Sum of MaxColumnWidth for all the elements to be
displayed on the Top Bar
MinSoftKeyWidth = Sum of MinColumnWidth for all the elements to be
displayed on the Softkey Bar
MaxSoftKeyWidth = Sum of MaxColumnWidth for all the elements to be
displayed on the Softkey Bar
MinWidth = Max (MinContentWidth, MinTopBarWidth,
MinSoftKeyWidth)
MaxWidth = Min (MinContentWidth, MinTopBarWidth,
MinSoftKeyWidth)
OverallMinWidth = Max (MinWidth across all screens)

According to some embodiments, a display top bar and a display soft key bar variables may be set. The application 304 may perform the user interface adjustment by performing vertical scaling 336, horizontal scaling 338, and font scaling 340 before the adjusted user interface is rendered (342) without having the application customized Vertical scaling may reject some displays if they do not meet minimum total row requirement. Otherwise, the height of the user interface to be displayed may be scaled based on a round-off function taking into consideration vertical resolution, vertical dots per millimeter (or inch) and minimum row height. The algorithm below is an example of how vertical scaling may be accomplished in an application according to embodiments.

NumTotalRows = RoundOff((VRes/VertDPM)/MinRowHt);
If (NumTotalRows < MinTotalRows)

Display cannot be supported

NumContentRows = NumTotalRows − ((DisplayTopBar == Y)?1:0) −
((DisplaySoftKeyBar == Y)?1:0)

Font scaling may be performed by adjusting font heights for a default display size based on vertical dots per millimeter (or inch). For example, 3.5″ QVGA is a common display format for small displays. For 3.5″ QVGA, the font heights are 3.52 mm and 4.23 mm and these are correspondingly 16 and 19 pixels high. Thus, an example algorithm may scale smaller and larger fonts as:

SmallerFont = 3.53*VertDPM
LargerFont = 4.23*VertDPM

For horizontal scaling, column widths may be recalibrated on the screen from default display definitions to the specific display. For example, if 3.5″ QVGA display is selected as default, the DPM parameter is 4.567 per mm. Thus, new column widths may be selected as the 3.5″ QVGA column width divided by 4.567 times the horizontal dots per mm parameter for the display. If the resulting overall minimum width is larger than the horizontal resolution of the display, the display may not be used for the application user interface. If the resulting overall minimum width is equal to or smaller than the horizontal resolution of the display, unused space on the screen may be reduced by readjusting some of the columns based on their definitions. This may be done, specifically, for top bar, soft key bar, and content areas. Below is an example algorithm for horizontal scaling in an application according to some embodiments.

```
// Recalibrate all ColumnWidth on the screen from 3.5 QVGA
definitions to the specific display
// 3.5 QVGA DPM = 4.567 per mm
NewColumnWidth = (3.5QVGAColumnWidth/4.567)*HoriDPM
If (OverallMinWidth > HRes)
  // Display cannot support screen definitions
If (OverallMinWidth < HRes)
  // Display can support screen definitions.
  // For each screen, for TopBar, SoftKeyBar, ContentArea
```

For (i = NumTotalColumns, i=1; i--)
{

If ((MinContentWidth − MinColumnWidth[i] +

MaxColumnWidth[i]) <= HRes))

Use MaxColumnWidth for column[i] when displaying

Else

Break;

}

In addition to the above discussed scaling operations, a scaling module according to embodiments may also perform adjustment of font sizes in case of rectangular fonts and associate columns, which are to be displayed with the same widths.

The different processes discussed in FIGS. 2 and 3 such as vertical scaling, font scaling, and horizontal scaling may be performed at distinct modules or at a single module using different scaling techniques and parameter definitions. Furthermore, different default display formats (e.g. other than 3.5″ QVGA) may implement a system using the principles described herein.

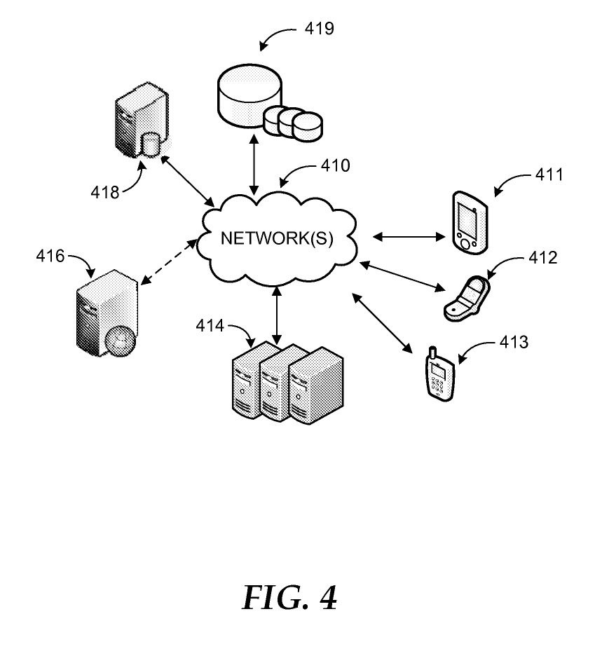

FIG. 4 is an example networked environment, where embodiments may be implemented. An application with automatically scalable user interface for different size and type of displays may be downloaded and installed from or executed in a distributed manner at a platform executed over one or more servers 414 or individual server 416 such as a hosted service. The platform may communicate with client devices such as a handheld computer 411, cellular phone 412, smart phone 413, or similar devices (‘client devices’) through network(s) 410.

Client devices 411-413 may interact with a hosted service and display the user interface for a hosted application from the servers 414, or on individual server 416. Each of the client devices 411-413 may have a display with a different size or type (e.g. resolution). Instead of customizing the hosted application for each different client device (i.e. display), a scaling module may perform vertical, horizontal, and font scaling as discussed previously and automatically adjust the user interface to respective display(s). Relevant data such as display characteristics may be stored and/or retrieved at/from data store(s) 419 directly or through database server 418.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also include (especially between the servers and the mobile devices) cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media. A display-agnostic user interface according to embodiments may also be implemented in non-networked devices.

Many other configurations of computing devices, applications, data sources, and data distribution systems may be employed to implement a platform providing display independent user interface for mobile devices. Furthermore, the networked environments discussed in FIG. 4 are for illustration purposes only. Embodiments are not limited to the example applications, modules, or processes.

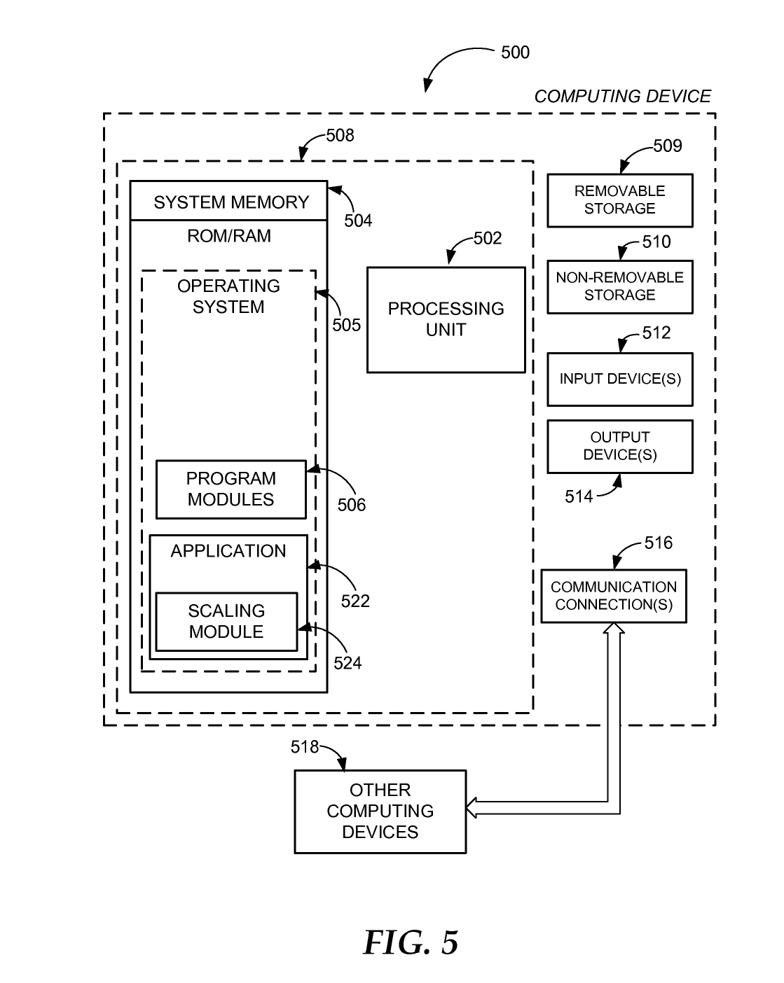

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be a mobile computing device according to embodiments and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS MOBILE® operating systems from MICROSOFT CORPORATION of Redmond, Wash. or similar ones. The system memory 504 may also include one or more software applications such as program modules 506, application 522, and scaling module 526.

Application 522 may perform any tasks that involve interaction with a user through a user interface. To avoid customization of the application user interface for different size or type displays, scaling module 524 may perform vertical, horizontal, and font scaling automatically adjusting the application's user interface to a particular display as discussed previously. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, other servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

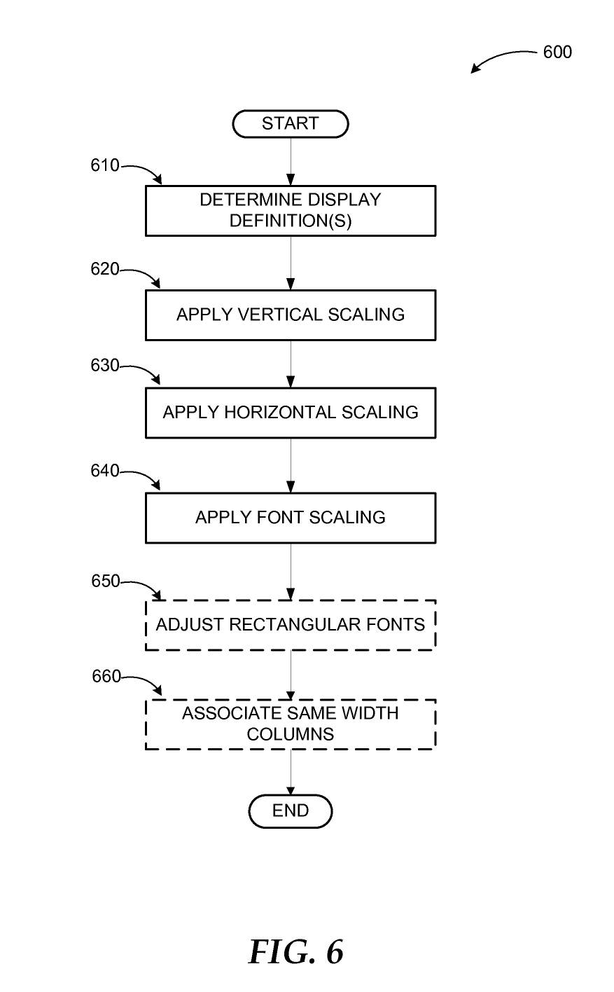

FIG. 6 illustrates a logic flow diagram for process 600 of scaling an application user interface according to embodiments. Process 600 may be implemented as part of a mapping application executed by a server.

Process 600 begins with operation 610, where display definitions may be determined such as a vertical and horizontal dimension of the display, a resolution of the display, etc. Embodiments may be implemented in square or rectangular displays. At operation 620, vertical scaling may be applied to the user interface followed by horizontal scaling at operation 630. At operation 640, font scaling may reduce (or increase) font sizes for optimum display.

At optional operation 650, rectangular fonts may be adjusted (e.g. if the user interface default is rectangular and the actual display is square or vice versa). At optional operation 660, columns which should be displayed with the same widths may be associated before the scaled user interface is rendered on the user device's display.

The operations included in process 600 are for illustration purposes. Automatically scaling an application user interface may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for adjusting an application user interface for different displays, the method comprising:
determining display definitions for a display to be used for rendering the user interface;
automatically applying at least one from a set of: vertical scaling, horizontal scaling, and font scaling based on the display definitions at runtime; and
rendering the adjusted user interface through the display.

2. The method of claim 1, wherein the vertical scaling comprises determining a height of the user interface employing a round-off function based on at least one from a set of: a vertical resolution of the display, a vertical dots per millimeter parameter of the display, and a minimum row height.

3. The method of claim 1, wherein the horizontal scaling comprises recalibrating column widths for the user interface by:
selecting a default display column width,
normalizing the default display column width by dividing by a default display dots per millimeter parameter, and
multiplying the normalized default display column width by a horizontal dots per millimeter parameter of the display.

4. The method of claim 3, further comprising:
if a resulting overall minimum width is larger than a horizontal resolution of the display, rejecting the adjustment.

5. The method of claim 3, further comprising:
if a resulting overall minimum width is one of equal and less than a horizontal resolution of the display, reducing unused space on the display by readjusting at least a portion of the columns based on their definitions.

6. The method of claim 5, wherein the readjustment is performed in at least one from a set of: a top bar area, a soft key bar area, and a content area of the display.

7. The method of claim 5, wherein readjusting the columns includes using a maximum column width for each column for which minimum content width minus minimum column width plus maximum column width is one of equal and less than a horizontal resolution of the display.

8. The method of claim 1, wherein font scaling comprises adjusting font heights for a default display size based on vertical dots per millimeter parameter of the display.

9. The method of claim 8, wherein two different font sizes are scaled.

10. The method of claim 1, further comprising adjusting rectangular fonts.

11. The method of claim 1, further comprising:
employing definitions for a default display format to apply vertical, horizontal, and font scaling, wherein the default display format is one of: Quarter Video Graphics Array (QVGA), Half VGA (HVGA), Half QVGA (HQVGA), Quarter QVGA (QQVGA), Quarter Extended Graphics Array (QXGA), and Half XGA (HXGA).

12. A computing device for executing an application capable of automatically adjusting a user interface to fit a display of the computing device, the computing device comprising:
a memory;
a display; and
a processor executing the application, wherein the application includes a scaling module configured to:
determine display definitions for the display to be used for rendering the user interface;
adjust a height and number of rows employing a round-off function based on at least one from a set of: a vertical resolution of the display, a vertical dots per millimeter parameter of the display, and a minimum row height;
adjust a size of columns based on a default display column width and a horizontal dots per millimeter parameter of the display; and
adjust a font height based on a default display font height and a vertical resolution of the display.

13. The computing device of claim 12, wherein the scaling module is further configured to:
adjust rectangular fonts; and
associate columns having same width to reduce unused space on the display.

14. The computing device of claim 12, wherein the scaling module is further configured to apply vertical, horizontal, and font scaling to different languages by selecting respective definition values for each applicable language.

15. The computing device of claim 12, wherein the display includes one of rectangular pixels and square pixels.

16. The computing device of claim 12, wherein the application is executed through one of: local installation at the computing device and distributed installation as a hosted application accessed by the computing device.

17. The computing device of claim 12, wherein the computing device is one from a set of:
a handheld computer, a smart phone, a cellular phone, a Voice Over Internet Protocol (VOIP) phone, a set top box, a vehicle mount computer, a tablet computer, a notebook computer, a netbook computer, and a wearable computer.

18. A computer-readable storage medium with instructions stored thereon for adjusting an application user interface for different displays, the instructions comprising:
determining display definitions for a display to be used for rendering the user interface;
performing vertical scaling by adjusting a height and number of rows employing a round-off function based on at least one from a set of: a vertical resolution of the display, a vertical dots per millimeter parameter of the display, and a minimum row height;
performing horizontal scaling by adjusting a size of columns based on a default display column width and a horizontal dots per millimeter parameter of the display;
performing font scaling by adjusting a font height based on a default display font height and a vertical resolution of the display;
adjusting rectangular fonts; and
associating columns having same width to reduce unused space on the display.

19. The computer-readable medium of claim 18, wherein the display definitions include at least one from a set of: a number and size of columns and rows; a vertical, a horizontal, and an overall resolution; presence of a top bar; presence of a soft key bar; sizes of top bar, soft key bar, and content area; and overall size of the display.

20. The computer-readable medium of claim 18, wherein the fonts share an attribute.
